(19) United States
(12) Patent Application Publication
(10) Pub. No.: US 2013/0159166 A1
(43) Pub. Date: Jun. 20, 2013

(54) Methods and Systems for Facilitating a Real Estate Transaction

(71) Applicant: Robert Graham Irick, Sullivan's Island, SC (US)

(72) Inventor: Robert Graham Irick, Sullivan's Island, SC (US)

(21) Appl. No.: 13/715,226

(22) Filed: Dec. 14, 2012

Related U.S. Application Data
(60) Provisional application No. 61/630,646, filed on Dec. 15, 2011.

(51) Int. Cl. G06Q 40/02; G06Q 50/16

(52) U.S. Cl. CPC G06Q 40/02; G06Q 50/16
USPC 705/38; 705/35

(57) ABSTRACT

Methods and systems for facilitating the sale of real estate, including receiving assets to be held in an account, restricting the account so that at least a portion of the assets are disbursed from the account to the buyer or a lender only if a loss resale event occurs in which the real estate is resold by the buyer or lender for a loss within a specified period, and in response to determining that the loss resale event has occurred, disbursing the portion of the assets to the buyer or lender to at least partially remedy the loss.

### RELATED APPLICATIONS

This application claims the benefit of U.S. Provisional Application No. 61/630,646 filed on Dec. 15, 2011, which is incorporated herein by reference.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates to systems and techniques for facilitating a real estate transaction. Such techniques can be used, for example, to create, manage, or otherwise use an agreement or other relationship between a buyer, seller, and/or other parties.

### BACKGROUND OF THE INVENTION

In the real estate market, empirical evidence suggests that nationally, banks and other financial institutions are selling real estate owned (“REO”) property at a significant discount, in some areas as much as a 40% discount as compared to market sellers. Such REO/Foreclosure sales can account for over 25% of a real estate market. Other empirical evidence suggests that the market is adversely affected when a substantial percentage of the existing housing inventory is sold well below the market value. The market seller is forced to lower the listing price to compete with the lower price offered by the REO seller. In subsequent sales, both the market seller and the REO seller are forced to lower listing prices even further because of legacy discounts previously offered.

By selling properties below market values, REO sellers relinquish a significant portion of the value of real estate portfolios to buyers. As shown in the examples that follow, many times this value is transferred to a buyer who is an investor who subsequently lists the REO property at market price. Often times the investor is able to transform much or all of the REO seller's discount into the investor's profit.

Numerous studies have used a myriad of financial statistics to determine whether REO asset managers receive less for the sale of portfolio properties than market sellers receive from the sale of their properties. The price differential between REO and market sales is referred to as the “foreclosure discount.” Many REO sellers argue that the foreclosure discount is the result of comparing properties with dissimilar physical characteristics. The REO sellers further argue that the hedonic regression methods used to calculate the foreclosure discount and the effect foreclosures have on neighboring properties fail to consider variables such as spatial proximity and property condition. However, for each empirical study of the foreclosure discount there seems to be counter-prevailing anecdotal evidence. Furthermore, for each illustration of the foreclosure discount using anecdotal evidence there appears to be counter-prevailing empirical evidence.

While the debate concerning which variables and metrics should be used to calculate the foreclosure discount may continue, potential buyers seem to have an immutable attitude toward REO properties. The ubiquitous “Bank Owned” sign, which is now a common marketing strategy for REO sellers, signals to potential buyer that the property will be sold at a deep discount.

### SUMMARY OF THE INVENTION

Whether rooted in statistics or attitudes, the foreclosure discount exists. While most data samples may contain anomalies, overall the sample data clearly displays the foreclosure discount. Implementation of a program to give potential buyers and/or lenders protection from losses upon a subsequent resale of a property will give REO sellers a mechanism to avoid or reduce the foreclosure discount. The marketing catch phrase “Bank Owned” can be replaced with a more attractive marketing phrase such as “Price Protection Guaranteed.”

The buyer and lender loss protection processes described herein can act to retain some or all of the previously forfeited value resulting from the foreclosure discount in an escrow account to serve as protection to the buyer and/or lender in the event that the buyer subsequently resells the property at a loss. This escrowed revenue results from selling an REO property at a value greater than what it would have been sold at with the foreclosure discount. In the event the property is not subsequently resold at a loss, then in accordance with processes described herein the escrowed revenue reverts back to the REO seller or its assigns at the end of a defined “at risk” period.

In accordance with the buyer and lender loss protection processes described herein, the REO property is listed for sale at a price above the price that would otherwise reflect the foreclosure discount—closer to or at market price. To compete with the surrounding market sales, a portion of the REO seller's proceeds designated a Guaranty Escrow Amount and determined based on the market value of the property, the foreclosure discount, and/or the actual purchase price of the property upon a sale from the seller to the buyer is placed into escrow to be used to offset possible future declines in market values. The Guaranty Escrow Amount serves to protect the established market value of the property from further declining in value and benefits both the lender as well as the buyer. If during a Guaranty Period there is a resale for a lower price than what was paid at the commencement of the Guaranty Period, the buyer and lender would have access to the Guaranty Escrow Amount to offset at least a portion of any loss arising from such resale event. If at the end of the Guaranty Period there is no resale event at such a lower price, the seller receives the full Guaranty Escrow Amount, including any increase in the amount due to investment of the Guaranty Escrow Amount in an investment vehicle, for example U.S. Treasury bills. This guaranty arrangement can be reflected in a Mortgage Collateral Certificate generated by the buyer and lender protection process described herein.

In accordance with one aspect of illustrative embodiments, buyer and/or lender loss protection is accomplished by a computer software system that is integrated at multiple levels with the operation and provision of market analysis, price analysis, and account management processes to provide REO sellers mechanisms to avoid the foreclosure discount in the sale of REO property by providing buyers and/or lenders protection against loss in a subsequent sale of the property.

In some embodiments, an automated software system makes use of various modules, some of which operate independently, and some of which advantageously integrate with existing systems thereby achieving maximum efficiency and transparency.

In some embodiments, a Guaranty Process module uses market research and metrics to determine a foreclosure discount in a given market and to determine an asset amount to be held as collateral against a future loss. In accordance with some embodiments of the Guaranty Process module, an REO property is listed for sale at a price above the price that would otherwise reflect the foreclosure discount—preferably (from the seller's perspective) at market price. To compete with the surrounding market sales, a portion of the seller's proceeds is designated a Guaranty Escrow Amount, which is determined based on the market value of the property, the foreclosure discount, and the actual purchase price of the property upon a sale from the seller to the buyer. The Guaranty Escrow Amount serves to protect the established market value of the property from further declining in value and benefits both the lender as well as the buyer. To document this guaranty arrangement between the seller, the buyer, and the lender the Guaranty Process module generates a Mortgage Collateral Certificate.

In some embodiments, a Negotiation Process module uses information about an offer price made by a potential buyer in seeking to purchase real estate; an estimate of the market value of the real estate; an estimate of the price of the REO property reflecting the foreclosure discount; and an amount of assets to be held in an account to determine an amount of a counter-offer that a seller should make to the potential buyer.

In some embodiments, an Escrow Account Management Process module determines a portion of a Guaranty Escrow Amount to be paid to a buyer or lender upon a loss resale event such as the subsequent sale of the purchased property at a loss. In some embodiments the Escrow Account Management Process module determines a portion of a Guaranty Escrow Amount to be paid to the original buyer of the property at such subsequent sale. If during a Guaranty Period there is a resale for a lower price than what was paid at the commencement of the Guaranty Period, the Escrow Account Management Process module provides the buyer and/or lender a portion of the Guaranty Escrow Amount to offset at least a portion of any loss arising from such resale event. The Escrow Account Management Process module provides any remaining portion of the Guaranty Escrow Amount to the original seller. If at the end of the Guaranty Period there is no resale event at such a lower price, the Escrow Account Management Process module provides the original seller the full Guaranty Escrow Amount.

### BRIEF DESCRIPTION OF THE DRAWINGS

These and other advantages of illustrative embodiments of the present invention will be apparent to those skilled in the art by reference to the following detailed description and the accompanying drawing figures, in which:

FIG. 1 illustrates an exemplary system in certain embodiments.

FIG. 2 is a flowchart illustrating functions performed by a Guaranty Process module according to certain embodiments.

FIG. 3 is a flowchart illustrating functions performed by a Negotiation Process module according to certain embodiments.

FIG. 4 is a flowchart illustrating functions performed by an Escrow Account Management Process module according to certain embodiments.

### DETAILED DESCRIPTION

Detailed embodiments are disclosed herein. However, it is to be understood that the disclosed embodiments are merely exemplary and that different embodiments are possible. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the present disclosure.

Computer systems and computer-implemented methods can support the exemplary transaction described above as well as other transactions contemplated by this disclosure. Illustrative systems and methods are discussed in the context of three process modules in exemplary embodiments.

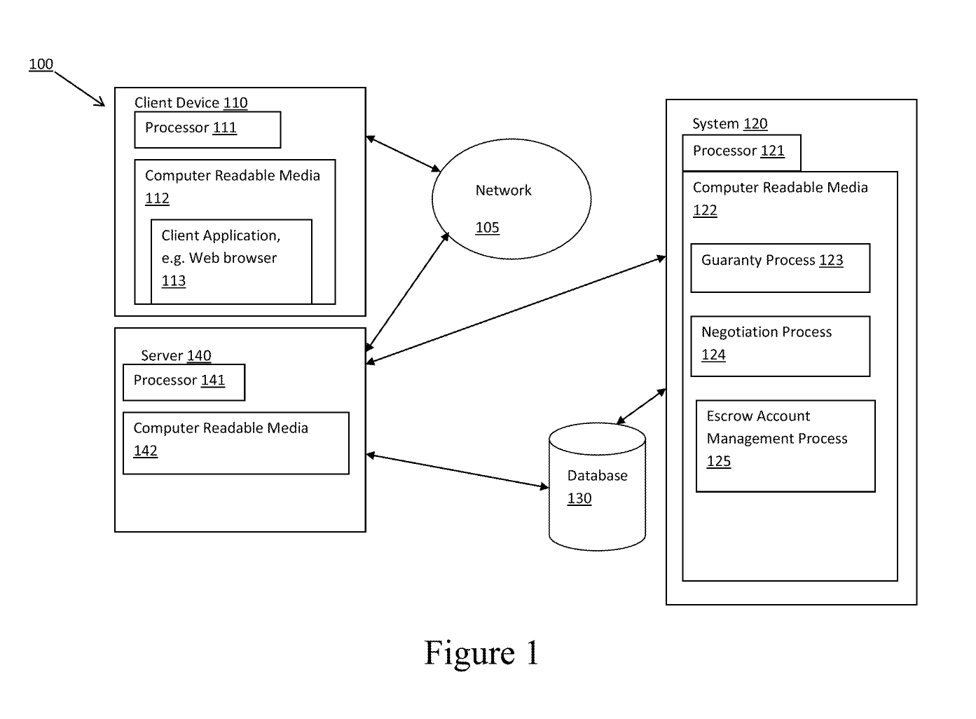

An exemplary embodiment provides for facilitating a real estate transaction by creating, managing, or otherwise using an agreement or other relationship between a buyer, seller, and/or other parties. FIG. 1 illustrates an exemplary system comprising a main system 120 with a processor 121 and computer readable media and storage capabilities 122. Stored within this main system is appropriate hardware, firmware, and/or software for implementing a guaranty process module 123, negotiation process module 124, and escrow account management process module 125. Coupled to the main system 120 is a database 130 comprising real estate, property, buyer, seller, and other records. Also coupled to the main system 120 is a server 140 comprising a processor 141 and computer readable media and storage capabilities 142. Server 140 is accessible by a client device 110 across a network 105 such as the Internet. Client device 110 comprises a processor 111 as well as computer readable media and storage capabilities 112 with client applications such as a web browser 113.

Applications and other electronic content execute or are otherwise used on the exemplary computer devices and are shown as functional components or modules. As is known to one of skill in the art, such applications and content may be resident in any suitable computer-readable medium and execute on any suitable processor. For example, as shown the client device 120 comprises a computer-readable medium such as a random access memory (RAM) 122 coupled to a processor 121 that executes computer-executable program instructions and/or accesses information stored in memory (not shown). Such a processor 121 may comprise a microprocessor, an ASIC, a state machine, or other processor, and can be any of a number of computer processors. Such a processor can comprise, or may be in communication with a computer-readable medium which stores instructions that, when executed by the processor, cause the processor to perform the steps described herein.

The client device 110 may also comprise a number of external or internal devices such as a mouse, a CD-ROM, DVD, a keyboard, a display, audio speakers, one or more microphones, or any other input or output devices. Device 110 could be a personal computing device, a mobile device, or any other type of electronic devices appropriate for providing one or more of the features described herein.

An exemplary computing environment providing systems and/or methods contemplated herein may comprise, for example, a wired or wireless network to which various devices or systems are connected. Other networks, intranets, or combinations of networks may be used. Other embodiments do not involve a network and may, for example, provide features on a single device or on devices that are directly connected to one another. Other alternative networks, computers, and electronic device configurations are also possible. In one embodiment, the client device is used by each of one or more of a buyer, a seller, a real estate agent, a lender, and/or an administrator to download access and update information that facilitates a real estate transaction. The client device may utilize functionality a local software application, web site, web portal, or otherwise.

A computer “device” or “system” refers to any computing or other electronic equipment that executes instructions and may include any type of processor-based equipment that operates an operating system or otherwise executes instructions. A device will typically include a processor that executes program instructions and may include external or internal components such as a mouse, a CD-ROM, DVD, a keyboard, a display, or other input or output equipment. Examples of devices are personal computers, digital assistants, personal digital assistants, cellular phones, mobile phones, smart phones, pagers, digital tablets, laptop computers, Internet appliances, other processor-based devices, and television viewing devices.

A computer-readable medium may comprise, but is not limited to, an electronic, optical, magnetic, or other storage device capable of providing a processor with computer-readable instructions. Other examples comprise, but are not limited to, a floppy disk, CD-ROM, DVD, magnetic disk, memory chip, ROM, RAM, an ASIC, a configured processor, optical storage, magnetic tape or other magnetic storage, flash memory, or any other medium from which a computer processor can read instructions. The instructions may comprise processor-specific instructions generated by a compiler and/or an interpreter from code written in any suitable computer-programming language, including, for example, JavaScript, ActionScript®, Java, Perl, C, C++, C#, Visual Basic, and Python. The instructions may be created using markup languages such as XML.

Information that facilitates a real estate transaction may be stored at and utilized by one or more server devices. For example, a client may access a server device, and the server device may access real estate statistical information stored locally or elsewhere to determine a hold value, counter offer, or any of the other determined information described herein, and provide that information to the client device. The determinations, requests for information, provision of information, and various other aspects of the exemplary processes described herein may be implemented via a computer system. For example, counter offers may be made available automatically on a website, web portal, sent via automatic e-mail, text (SMS) messaging, or otherwise through the use of a computer system or method. The information referred to includes the critical data and criterion outlined herein and used to establish the Reserve, hold period, and total term. Also, systems and methods may facilitate communications between Lenders, Realtors, and protection provider, relating to offers and the automatic responses for counter offers, the ordering of credit reports, locking of the loan and all terms, and closing documents associated with each lender and loan type. Listings will be registered with the Protection Provider and each change in property status will be communicated and effectuate all necessary changes in the status reports and needed procedural actions, i.e. the ordering of closing documents, setting of closing date, time, attorney, and location. Also, all pertinent lender information and documents that need to be in hand at closing will be communicated automatically to all parties to avoid confusion and to give all parties a documented path of communication.

### Guaranty Process

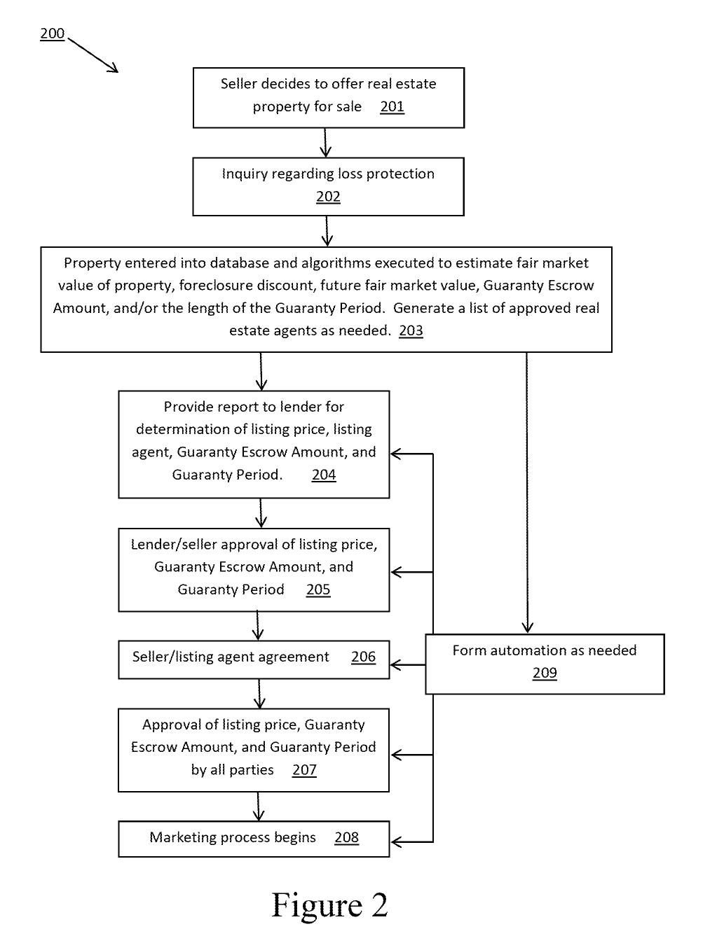

FIG. 2 illustrates processes performed by a Guaranty Process Module 200 according to certain embodiments. The guaranty process begins at box 201 where a real estate seller decides to sell a property. The process then proceeds to box 202 where the seller contacts the entity implementing the buyer/lender protection process described herein contacts a real estate agent with a relationship with the implementing the buyer/lender protection process described herein. At box 203, several actions occur. The property is entered into the database of the system and algorithms are executed to estimate the market value of the property, the foreclosure discount, future market value, the Guaranty Escrow Amount, and/or the length of the Guaranty Period. In addition, if at box 202 the seller had not contacted an approved real estate agent, the system generates a list of approved real estate agents. The process then proceeds to box 204 where the system provides a report to the seller for determination of a listing price, a listing agent, and the Guaranty Escrow Amount and Guaranty Period. At box 205 the institution approves these determinations and the information, and the listing agent then enters into an agreement with the seller at box 206. At box 207, all parties including the seller, the listing agent, and the institution agree on the listing price, the Guaranty Escrow Amount, and the Guaranty Period, and at box 208 the marketing process for the property begins. In addition, at box 209 form automation can provide necessary documents throughout the process.

In certain embodiments, the Guaranty Process Module 200 assists in determining realtor recommendation, determining market value, determining future value and/or potential appreciation, determining a recommended Guaranty Escrow Amount, and determining a recommended Guaranty Period during which the Guaranty Escrow Amount may be held. These determinations may involve one or more algorithms that are implemented on a computer system or via a computer-implemented method that provides the information based on one or more of the following criterion for each home for the determined subject market. In such exemplary determinations, information can be obtained from multiple sources including, for example, from homeowner disclosure forms, which may provide state specific information relating to previous market sales. Exemplary criterion include, but are not limited to, the following:

1. Listings data in market area over a prior time period:
Multiple listings may be tracked for a period of time, e.g. 24 months, for market area as determined by local registered and participating Realtors.
Breakdown of percentage of Homeowner to Foreclosure/Short Sale listings.
Time on the market for each category of both Homeowner and Foreclosure/Short Sale listing including size of home, price point, condition, primary residence, investment property, second home or other before sold.
Listings to Sales comparison by agents and Real Estate companies.
Time on the market for each neighborhood/market area as agreed upon by registered agents in the overall market area.
Realtor Listings may be compared to the same Realtor Sales to determine if Realtor is also actively representing buyers as well.

2. Realtor listings in market area over the prior time period. Compare listings to subject for size, condition, location, and all criterions established in the following #21 with each Realtor and Real Estate Company. Determine which company and Realtor listed and which Realtor and company represented the buyer for the sale.

3. Offers as a percentage of the listed price of Realtor. Track each Realtor offers in the market area for patterns of offers as compared to listed price. Does selling Realtor represent more primary homebuyers, investors, or second homebuyers? Does offering price to listed price reflect any pattern for Realtor, buyer type, or any other item in #21 that shows any Realtor or market trend? Much of this may be reflected in item #1.

4. Offers as percentage of listed price of other Realtors to listed price of Listing

Realtor. Determine offers and sale prices for each listing agent as a percentage of final sale price to determine Realtor patterns and ability to properly price neighborhood homes and deliver contracts at prices close to listing price.

5. Track the time required from listing to contract to final closing for each Realtor listing.

6. Time to sell other Realtors listings. Compare time associated with selling other Realtor listings as compared to performance on selling personal listings.

7. Estimated value of real estate listed, both total and per unit, as compared to estimated market value. Values to be determined by taking the Overall Market REO Discount as determined by, for example, RealtyTrac and add value back to all REO Sales. Compare total REO to Homeowner sales percentages in Overall Market to Subject Market and make adjustments for the REO Discounting on the Homeowner values and sales.

8. Estimated value of real estate listed by other Realtors, both total and per unit, as compared to estimated market value. Values to be determined by taking the Overall Market REO Discount as determined by, for example, RealtyTrac and add value back to all REO Sales. Compare total REO to Homeowner sales percentages in Overall Market to Subject Market and make adjustments for the REO Discounting on the Homeowner values and sales.

9. Sales volume and listing volume of each Realtor as a percentage of total market, total dollar volume and number of units.

10. Number of sales in Market Area over a period of time, e.g. the past 24 months, including all categories of buyers, home type and condition, seller type, and price ranges.

11. Number of sales in Market Area over a period of time, e.g. the past 24 months by each Realtor, including all categories of buyers, home type and condition, seller type, and price ranges.

12. Total volume of all sales, including all categories of buyers, home type and condition, seller type, and price ranges.

13. Total volume of REO Sales, including all categories of buyers, home type and condition, seller type, and price ranges.

14. Total volume of Homeowner Sales, including all categories of buyers, home type and condition, seller type, and price ranges.

15. REO Sales volume/house as compared to Homeowner Sales volume/house in whole market area.

16. REO Sales volume/house as compared to Homeowner Sales volume/house in an area, e.g. a 3 mile radius.

17. REO Sales volume, both in numbers of homes and dollar volume as compared to

Homeowner Sales volume using the same criterion in various areas, e.g. a 2 mile radius, a 5 mile radius, and entire market area.

18. REO Sales volume both in numbers of homes and dollar volume as compared to Homeowner Sales using the same criterion in an area, e.g. a 1 mile radius

19. REO Sales both in numbers of homes and dollar volume as compared to Homeowner Sales using the same criterion in ½ mile radius, where available

20. Compare each category for REO and Homeowner Sale to determine REO discount for Escrow recommendation. When the determination of the REO Discount is made, the REO Seller will be recommended to use the REO Discount in the subject market to determine the List Price or Market Price. The percentage REO Discount can be the recommended percentage of the list price as the Reserve. This Reserve is effectively the same amount of revenue previously being relinquished by the Seller when Seller was willing to accept deeply discounted prices well below the actual Market Value.

21. Compare each home in each category interior and exterior characteristics, interior and exterior conditions, square footage, lot size, etc. amenities for REO and Homeowner to determine REO discount as well as future likelihood of expected timeframe of the return of market stabilization. The factors most often associated with the strongest of markets will dictate shorter lockout periods and shorter terms. If the market reflects below national REO Discounting, historical stability, fewer foreclosures as compared to overall offerings, high neighborhood desirability, property is in excellent condition, and high ratings in all categories associated with desirable characteristics, then the system will recommend a lower reserve to enhance the sale with a shorter term and hold period. The Reserve may be, for example, 10% rather than the expected typical 25% with a minimum required hold period of 2 years and full coverage term of 4 years. In markets and neighborhoods where the converse seems to prevail, the recommended Reserve may be, for example, 35% with a 3-year minimum required hold period and a 7-year full coverage term. These conditions reflect the reluctance of Buyers to purchase and typically reflect a longer timeframe to sell at deeper discounts. To overcome these fears, limitations, or restraints, the system can recommend enhanced terms and conditions for the Seller to offer to effectuate quicker and more attractive sale terms. For these Escrow recommendations, all market conditions may be taken into consideration using a weighted rating chart. This chart can be established using all, but not exclusively the following categories applying, for example, a −5 through a +5 rating by the listing registered agent based upon visual inspection and market knowledge. Also, each market's “Seller Property Disclosure” may be given a weighted percentage of the total of 25% using the same grading scale. If the first set of categories receive a 2.5 rating and the “Seller Property disclosure” is found by the Listing Realtor to be a 4.5, then the overall rating of 3.0 would be given to the property. At zero, the system may recommend the national average of REO Discount for the Reserve with terms of a 2-year hold and a 5-year expiration. Each point below zero may require an additional 2% and 6 months additional time added to the hold and expiration timeframes. The converse is true for above zero ratings with the hold and expiration being capped at one year of reduction at a positive 4 rating. The 75% categories may include:
Average Income
School Systems
Higher Property Tax Base
Public Transportation
Traffic Count
Insurance cost
Hospital Proximity
Restaurant Proximity
Entertainment Proximity
Shopping Proximity for necessities
Shopping Proximity for non-necessity items
Historical Appreciation/Stability
Neighborhood Foreclosure History
Average Time on Market
Proximity to employment
Proximity to Parks and Recreation
Home Exterior Condition
Home Interior Condition
Landscape
Flood Zone
Neighborhood stability
Roof Type
Gutters and Type
Any Structural conditions negatively impacting value
Any interior obsolescence
Interior Design
Curb Appeal
Neighborhood Amenities
Interior Systems for vacuum, security, or home operation and efficiency
Fencing and type
Patio
Patio amenities
Sprinkler system
Well system
Public Utilities
Gazebo
Hot tub
Pool
Energy efficient systems
Solar panels
Built in entertainment systems
Exterior storage
Energy Efficient windows
Garage/Parking
Traffic Conditions
Extremely Poor Condition
Extremely Poor Location
Extremely High Noise
Extremely High Crime
Ceiling Height
Extremely Overbuilt
Age and condition of Appliances
Premium Landscape and Grounds
Updated Kitchens
Updated Baths
Premium view
Premium HVAC
Updated Appliances

22. Sales data for a period of time, e.g. the past 24 months may be used for baseline.

23. All REO Sales can be removed from sales data to determine Market Value.

24. All sales with contracts or offers within a period of time, e.g. 30 days of listing date can be excluded.

25. All Short Sales can be excluded.

26. Market area with REO sales in excess of national average may receive add-on for excessive REO Discounting.

27. Compare sales to listings in immediate market area to sales in expanded market area and then as compared to overall market area to determine likely stabilization and future appreciation probability and expected potential appreciation rate above overall market.

28. Realtor rating of neighborhood for overall desirability.

29. Use historic sales data to determine progression of recommended Reserve recommended to accompany or be associated with offers and counteroffers.

### Negotiation Process

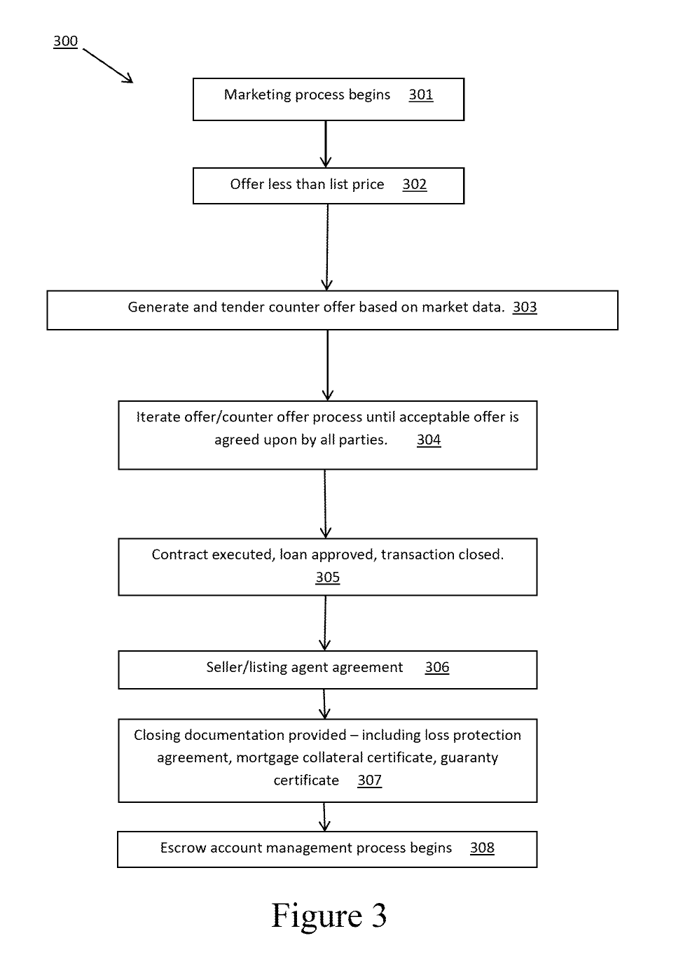

FIG. 3 illustrates processes performed by a Negotiation Process Module 300 according to certain embodiments. The negotiation process begins at box 301 where the property is being marketed for sale. At box 302 a potential buyer offers less than the listing price, and at box 303 the process generates a counter offer based on the relevant market data stored within the system and tenders this counter offer to the potential buyer. At box 304 the process continues with the potential buyer and the system exchanging offers and counter offers automatically generated by the system until a sale price is agreed upon. At box 305, the transaction is executed and closed whereas at box 306 the parties execute the necessary documents to memorialize the buyer/lender loss protection agreement reflected in the Guaranty Escrow Amount and the Guaranty Period. At box 307 the Guaranty Escrow Amount is invested in an appropriate manner to be held and managed during the Guaranty Period.

In certain embodiments, the Negotiation Process Module 300 may involve exemplary processes occurring post listing through closing, such as:

1. Determining counter offer values, perhaps specific to each market area. This process may have a disproportionate sliding scale of Reserve reduction predetermined based upon the offering price. As the offer is reduced, the Reserve may also be reduced, but at an increasingly greater rate. This is to encourage the potential buyer to pay market price if they want full price protection coupled with greater benefits relating to the loan conditions as well as rate and terms. There could be a predetermined counter offer prepared and returned to offering Realtor based upon the percentage of offer as it relates to the asking price if Seller chooses to use an automated counter offer program. These predetermined algorithms may be modified to and adapted to each market according to the extent of the devastation. Markets experiencing higher than average REO sales and discounts may have higher Reserves and less reduction with lower offers than stronger markets. Also, REO Sellers can determine how aggressive they would like counter offers to be, market by market, based on the same type of criterion. Homeowners may choose to be more personally involved than holders of large amounts of inventory therefore requiring seller input on each counter offer. Some or all counteroffers can be generated manually.

2. Providing a realtor with data for listing and make available automatic counter offer services, e.g., a 24 hour assurance of an automatic counter offer response. The current environment of long delays has had a profound impact on offers and sales of REO inventory as stated by all media and publications. The system may have predetermined algorithms set that can generate automatic responses to the initial offers and in some cases, for every offer. This would encourage the Realtors to submit offers on REO Properties as opposed to shying away from them, as is the current practice. The previously mentioned algorithms may be developed, market by market based upon the level of devastation being experienced by the subject neighborhood. This can be determined by previously mentioned criterion such as level of REO Discount, number of foreclosed properties as a percentage of total listings, etc.

3. Providing information on approved lenders.

4. Provide information to give the realtors a definitive answer to all loan data as it relates to the sale.
Interest rate may be specific to each of different levels of a reserve. The interest rate by mortgage lenders has always been a product of the associated risk with the borrower down payment, loan-to-value amount, borrower credit score, property condition and location, as well as many other conditions used to establish rates and terms. The system may have all participating lender's established criterion imbedded in individual rate sheets. As the interest rate market changes, the lenders can have algorithms set that will impact the rate quotes as it relates to the borrower's credit score, down payment, as well as percentage of Reserve and the conditions that apply to the Reserve.
Credit score needed to qualify based upon income vs. mortgage costs ratio (interest rate can change at different levels of the combination of loan-to-value amount, credit score, and protection) can increase or decrease mortgage costs specific to each level of down payment and/or reserve. Each lender can provide protection with their terms relating to the impact of each level of down payment coupled with the percentage of Reserve will have on their loan terms. The conditions affecting the loan terms can be based upon where the Escrow Reserve will be held, the level or percentage of Reserve, the type of instrument in which the reserve will be invested (i.e. Cash, U.S. Treasuries, Bank Notes, NYSE, etc.), borrower credit score, down payment, borrower's ratio of income to overall debt as well as loan debt and costs, borrower's ratio of income to loan costs, if the borrower will be allowed to participate in the Reserve if all payments are made on a timely basis, and what level is offered to the buyer. The lender may ask the an administrator of the system to develop a grid combining all these criterion and the level of importance each item will have relating to the loan terms and borrower-related decisions. The borrower may be able to see what each lender is offering at that point in time and all criterion they take into consideration for offering the posted terms and conditions. The lender and borrower may agree to lock the interest rate on the prospective loan before closing, for a period of time.
All loan products available and the impact of all offers as it relates to Reserves, loan-to-value amount, etc.
With each offer, provide a recommended and counter offer with the loan criterion available through an attached portal if buyer wants to consider the counter.
Algorithm Grids offering all criteria for each offer as it relates to each Lender including all combinations of Reserve, term, buyer down payment, borrower credit score, lock-in period, estimated closing date. As price changes, so does loan-to-value amount since the offering price should actually be at or close to the market value. As loan-to-value amount, down payment, and Reserves change, the changes can be fed into the system impacting each lender's preferences as it relates to their required and desired criterion as it relates to the property, borrower, and added security. As the criterion increases the lender perceived security, terms and conditions would change to reflect the importance of each individual change to each lender.

5. Offer terms are agreed upon by all parties and contract is executed with notifications sent to all involved parties.

6. Buyer chooses loan product that fits their needs most appropriately and begins loan process with chosen lender.

7. Lender notifies the system of loan decision and desire to have issued a Mortgage Collateral Certificate at closing with their pertinent data.

8. Buyer receives loan approval and closing date and closing agent are chosen with notifications going to all involved parties.

9. Closing agent is forwarded all documentation from lender.

10. Closing agent is sent all documentation and instructions.

11. Seller executes Agreement offering Buyer and Lender access to Escrow.

12. Lender receives Mortgage Collateral Certificate.

13. Buyer receives Guarantee Certificate.

14. Designated Escrow Agent executes documentation and receives Escrow funds.

15. Loan is funded and agreed term and conditions begins.

In certain embodiments, a lender may require or desire or allow for mitigating underwriting factors if there is an escrow for principal and interest escrow in addition to the Guaranty Escrow Amount. Such provision would designate a portion of the escrow as a P&I Escrow Amount to be available to be applied against the principal and interest obligation at any time during the Guaranty Period in the event of a principal-and-interest default by the buyer/borrower.

The P&I Escrow Amount in some embodiments can be held as a separate escrow established at the same time the Guaranty Escrow Amount is established. Financial instruments acceptable for this provision include without limitation a letter of credit from an acceptable source. The letter of credit may or may not have a security interest in the Guaranty Escrow Amount but does not require the escrow to be divided at closing into two separate accounts.

### Establishing New or Modified Escrow Account

In certain embodiments, establishment of all or a portion of the Guaranty Escrow Amount results from a refinancing, other loan modification event. This may involve receiving assets to be held in an account, the assets associated with real-estate secured lending (e.g., involving refinancing or other loan modification) from a lender to a borrower. The account may be restricted so that assets are disbursed from the account to the borrower or the lender only if a triggering event occurs within a specified period. For example, in response to the occurrence of a triggering event it may be determined to disburse a portion (some or all) of the assets to the borrower or lender based at least in part on the occurrence of (a) a sale price less than a value of the real estate determined at the time of the lending or (b) on an appraisal or the like determining that the market value of the real estate is less than a value of the real estate determined at the time of the lending. Such an appraisal may be associated with a refinancing or other loan modification event.

### Escrow Account Management Process

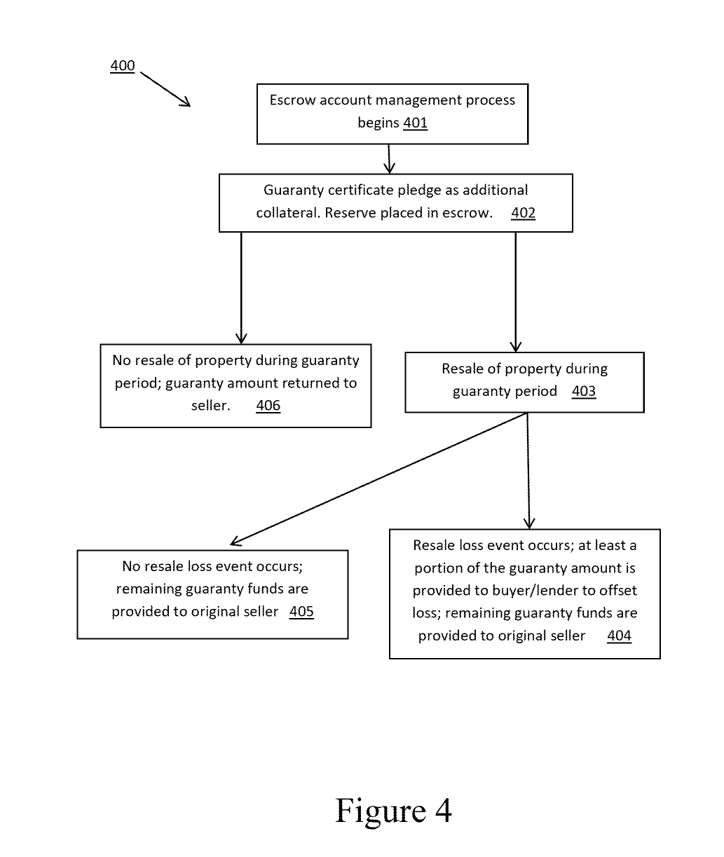

FIG. 4 illustrates processes performed by an Escrow Account Management Process Module 400 according to certain embodiments. The escrow account management process begins at box 401 where the Guaranty Escrow Amount is being held in an investment or other account. At box 402 insurance, designated herein as a Guaranty Certificate Pledge, is provided for the benefit of the lender to insure that the Escrow Account Management duties are performed. In addition, the Guaranty Escrow Amount is placed into escrow. At box 403, the buyer decides to resell the property during the Guaranty Period. If the buyer resells the property for an amount less than the original purchase price, i.e. a resale loss event occurs, then at box 404 the process provides a portion of the Guaranty Escrow Amount as an offset against the buyer's (or lender's as appropriate) loss. If any of the Guaranty Escrow Amount remains after the set-off against the loss, such remaining funds are then provided to the original seller. Returning to box 403, if the buyer resells the property at a price equal to or above the original sale price, then the process branches to box 405 and the entire Guaranty Escrow Amount is returned to the seller. Similarly, returning to box 402, if the buyer retains ownership of the property until the end of the Guaranty Period, then the process branches to box 406 and the entire Guaranty Escrow Amount is returned to the seller.

In certain embodiments, disbursement of all or a portion of the Guaranty Escrow Amount results from a refinancing, other loan modification event, or other triggering event during the Guaranty Period rather than by an outright sale by the buyer. As examples, if upon the occurrence of the refinancing or other loan modification, an appraisal confirms that the market value of the property is less than the original purchase price, then this occurrence can also represent a resale loss event that triggers a disbursement. The disbursement may be reduced in such circumstances, for example, to account for the cost of a sale transaction or other factors. In addition, in certain embodiments the buyer may at the buyer's discretion request disbursement of all or a portion of the Guaranty Escrow amount during the Guaranty Period. In such an example, if an appraisal confirms that at that time of the requested disbursement, the market value of the property is less than the original sale price, a disbursement can occur. An agreement can thus include a refinance provision that allows for a disbursement if there is a decrease in value. An agreement can additionally or alternatively include a refinance provision that provides for release of a portion or all of the Guaranty Escrow at certain levels of increased value.

In certain embodiments, the escrow account management process may facilitate certain activities pertaining to post-closing implementation of the agreement embodied in a Mortgage Collateral Certificate such as, for example:
Preapproved investment instrument is purchased by escrow agent.
All parties notified of investment and terms.
The system begins annual monitoring of market conditions and investment status.

In some embodiments, mechanisms, procedures, and/or provisions for managing the P&I Escrow Amount can be established by the lender as it relates to the size required for the P&I Escrow Amount, provisions relating to time period during which the P&I Escrow Amount should remain in place (for instance, if a borrower has “x” late payments, the P&I Escrow Amount may continue after the release of the Guaranty Escrow Amount), and what is considered an acceptable security instrument or collateral for the P&I Escrow Amount. Such mechanisms, procedures, and/or provisions can define the principal-and-interest default events that trigger disbursement and, for example, provide that the P&I Escrow Amount 1) be disbursed after “x” days delinquent and going forward, 2) be available for disbursement at any time borrower is 30 days delinquent, and/or 3) be available for disbursement on a payment by payment basis.

In some embodiments, the borrower can be responsible to the seller for the P&I Escrow Amount, which will be due when the Guaranty Escrow Amount is released, unless market conditions and valuations remove the seller as a potential participant in the escrow. If the seller is not repaid at the escrow release date, the seller can get a security interest in the real estate property for the funds that have been removed from the P&I Escrow Amount, plus interest, payable upon sale or transfer of the home. This security interest cannot facilitate a default triggering a loan acceleration. Also, as is the case with the Guaranty Escrow Amount, buyer, seller, and/or lender may negotiate these funds to be “forgiven” or remain at the release of the Guaranty Escrow Amount.

### RESIDENTIAL EXAMPLE

This section provides an example for illustrative purposes only. Nothing in this section is intended to restrict the scope of the inventions that are described in the claims appended hereto. Assume that a market value of foreclosed or REO House is $125,000, if sold by Homeowner. In this example, it can be estimated that the same home would sell for $57,500 by the REO holder as a foreclosure based upon national REO Discount Data in today's environment. In this example the market area is discounted by REO Sellers by an average of 45%. Average discount can be determined, for example, by comparing the homeowner sales and REO sales in the same neighborhoods and geographic regions.

A sale price and a percentage of resale price protection are determined based on the home and/or neighborhood sales data. In this example, the REO seller offers the house for $125,000 with 45% resale price protection. The sale price can be an average comparable homeowner neighborhood price and may be adjusted to account for variables. The REO Discount for the area is determined based on statistical data and in this example is 45%. The determined area REO discount is used as the resale price protection value in this example. It is offered as Reserve or price protection to break the established REO expected practice of selling well below the market price. The Reserve is available for a period of time, in this example, for 5 years. In this example, the five year period is determined based on determining that 5 years is the historical number of years that a seasoned mortgage is no longer considered a foreclosure threat. While that may not be the case today, as we return to normalcy, the relevance of such historical based numbers increases. These conditions and price are accompanied only with a full price offer. Seller may also offer the option of sharing a percentage, say 25%, of the Escrow with Buyer/Mortgagor at maturity based on loan payment performance. Various enticements can be employed to make for an attractive security to be sold in the open market. Generally, the more the borrower is encouraged to make timely payments, the more attractive the security. Therefore, the better price the mortgage seller gets for the loan, the greater the Reserve which allows for a lower rate (less risk) which makes the borrower able to borrow more and/or pay more for the home as well. A lower rate results in a lower monthly mortgage payment which increases the borrower income to mortgage payment or debt ratio, thereby resulting in a loan with a higher level of security.

In this example, the final negotiated contract of sale price is $115,500 with the Seller offering Resale Price Protection of 20%. This is strictly a hypothetical negotiated sale. The model can automatically determine and provide a sliding scale of recommended Reserve for the sale price that has a reverse correlation to the Buyer offered price if reduced. The higher the price, the more Reserve. A reduction in the offer of $20,000 will reduce the reserve more than $20,000, for example, reducing it by $30,000. This allows the borrower to focus on what is most important to the borrower, Price, Protection, better rate because the lender has more security in escrow, or lender credit score mitigation for the same reason. In highly volatile areas, the system may recommend 6 or 7 years, according to market conditions and history experienced by the market area. This negotiated sale has resulted in the foreclosure discount being reduced to 8% from 45%.

20% of sales proceeds fund the Escrow Reserve (20%×$115,500) or $23,100. Recaptured equity of previously forfeited REO Discount funded at closing of $34,900 ($115,500 (purchase price)−$23,100 (Escrow Reserve)=$92,400 (funded to seller at closing)−$57,500 (REO Price)=$34,900 in excess funds realized at closing in addition to the otherwise $57,500 REO Price). Total of $58,000 in potential unrealized equity to seller before fees after maturity of 5 year holding period ($34,900 in excess funds at closing+$23,100 Reserve=$58,000).

Using the System nets Seller a potential of $58,000 in additional funds. Note: Initial Offering nets Seller $110,938 ($125,000 minus the 25% protection sharing or 25% of $56,250=$14,062 or $125,000−$14,062=$110,938 the likelihood of this borrower staying with the loan and returning all protected sums to seller is greater than without sharing feature which justifies a lesser final price, Final Sale, $115,500 (final agreed upon price of $115,500 with 20% which nets $115,500 at the end of 5 years if the borrower stays with the loan and purchase).

### Guaranty Escrow Agreement Example

For purposes of illustration, exemplary provisions of an exemplary Guaranty Escrow Agreement are provided. The provisions provided below are exemplary and thus can be used, not used, or modified as is appropriate in the particular circumstances and context. Moreover, the definitions used in this exemplary agreement are applicable only to this exemplary agreement and thus should not be used in limiting or otherwise construing the terms and phrases as used elsewhere in the claims and specification of this patent.

THIS ESCROW AGREEMENT (the “Escrow Agreement”), made and entered into as of the _____ day of _____, by and among _____ (“Purchaser”), _____ (“Seller”), _____ (“Mortgage Lender”) and BUYERS & LENDERS LOSS PROTECTION, LLC (“BLLP”) as Escrow Agent:

WITNESSETH:

WHEREAS, Seller and Purchaser entered into that certain Purchase and Sale Agreement dated _____ (the “Purchase Agreement”) relating to property more particularly described in Exhibit “A” attached hereto and made a part hereof by reference (“Property”); and

WHEREAS, Seller, Purchaser and Mortgage Lender have elected to participate in the BLLP Guaranty Program (“Program”) and have requested that BLLP serve as the Escrow Agent for the purposes of implementing the terms and conditions of Program as herein set forth.

NOW, THEREFORE, in consideration of the mutual covenants herein contained and for other good and valuable consideration, the receipt and sufficiency of which are hereby acknowledged, the parties hereto, intending to be legally bound, hereby agree as follows:

ARTICLE I

DEFINITIONS, RULES OF INTERPRETATION AND STANDARDS

Section 1.01. Definitions. The following words and phrases shall have the following meanings^{.}

“Agreement” means this Escrow Agreement and all schedules, exhibits, amendments and supplements thereto and hereto.

“Appraisal” means the appraisal of the Property performed in accordance with and pursuant to Article VI of this Escrow Agreement.

“Borrower” means any person who would qualify as a Mortgagor but as to which the closing of a Mortgage Loan has not yet occurred.

“Business Day” means any day other than (i) a Saturday or Sunday, or (ii) a day on which banking institutions in New York, New York, or the state in which this Agreement is executed, are authorized or required by law or executive order to close, or (iii) a day on which the New York Stock Exchange is closed.

“Closing” and “Closing Date” mean the transfer of the title to the Property as defined herein, from the Seller to the Purchaser and the simultaneous the funding of the Mortgage Loan by the Mortgage Lender and the execution and delivery by the Mortgagor of all documents in connection therewith and the date on which such closing occurs.

“Code” means the Internal Revenue Code of 1986, as amended, and all subsequent tax legislation duly enacted by the Congress of the United States of America.

“Commit” or “Commitment” means a binding written commitment by the Mortgage Lender, in the form customarily used by the Mortgage Lender in its owner-occupied home lending practice or in a form customarily used in the mortgage lending industry as may be specified by the Servicer, to a particular Eligible Mortgagor to finance the purchase of a particular Single Family Residence with a Mortgage Loan, which Commitment shall specify a stated expiration date, a stated principal amount and an interest rate equal to the Loan Rate.

“Compliance Package” or “Prior Approval Request” means the documents required to be submitted to the Escrow Agent in connection with a request to participate in the BLLP Guaranty Program.

“Conventional Mortgage Loan” means a Mortgage Loan other than an FHA Insured Mortgage Loan, VA Guaranteed Mortgage Loan, or a USDA Rural Development Guaranteed Mortgage Loan, satisfying the requirements of Fannie Mae or Freddie Mac, as applicable.

“Cure Period” shall have the meaning assigned to it in Section 4.12 hereof.

“Default” means one of the events specified in Section 7.01 hereof.

“Eligible Mortgagor” means a Mortgagor or Mortgagors (i) intending to occupy a Single Family Residence as its or their principal residence within sixty (60) days after the Closing Date and intending to principally and permanently reside as a household in a Single Family Residence.

“Escrow Account” means the account by that name created pursuant to Article IV of this Escrow Agreement.

“Fannie Mae” means Fannie Mae, a federally chartered and stockholder-owned corporation organized and existing under the Federal National Mortgage Association Charter Act (12 U.S.C. Section 1716 et seq.), and any successor to its functions.

“FDIC” means the Federal Deposit Insurance Corporation, or any successor to its functions.

“FHA” means the Federal Housing Administration of the United States Department of Housing and Urban Development, and any successor to its functions.

“Freddie Mac” means Freddie Mac, a shareholder-owned government-sponsored enterprise created on Jul. 24, 1970, pursuant to the Federal Home Loan Mortgage Corporation Act, Title III of the Emergency Home Finance Act of 1970, as amended, and any successor to its functions.

“Loan” means the debt evidenced by the Mortgage Note.

“Loan Rate” means the interest rate per annum with respect to the Mortgage Loan obtained by the Borrower.

“Mortgage” means the written instrument securing the related Mortgage Loan and encumbering a Single Family Residence,

“Mortgage Lender” or “the Mortgage Lender” means the party executing this Agreement on the final execution page hereof, being a home mortgage lending institution or entity approved by the Escrow Agent to participate in the BLLP Guaranty Program.

“Mortgage Loan” means a mortgage loan to an Eligible Mortgagor evidenced by a Mortgage Note secured by a related Mortgage on a Single Family Residence.

“Mortgage Note” means the written instrument executed to evidence the Mortgagor's obligation to repay the Mortgage Loan.

“Mortgagor” means any person who has a present ownership interest in a Single Family Residence subject to the related Mortgage and/or executes the Mortgage.

“Notice Address” means:

(a) As to the Escrow Agent: BLLP, Atlanta, Georgia Attention: Director of Legal Affairs

(b) As to the Seller:

(c) As to the Purchaser:

(d) As to the Mortgage Lender:

“Property” means the real property described on Exhibit “A” and all improvements and fixtures thereon.

“Purchase” means the purchase of the Property by the Purchaser.

“Purchase Date” means date of Closing as defined herein.

“Purchase Price” means the cost of acquiring the Property from the Seller thereof.

“Qualified Appraiser” means an individual that is accepted by FHA, VA, Fannie Mae or Freddie Mac and BLLP, as applicable and licensed in the state in which the property is located.

“RESPA” means the Real Estate Settlement Procedures Act (12 U.S.C. §2601 et seq.) and its implementing regulation, Regulation X (24 C.F.R. Part 3500), as they might be amended from time to time, or any additional or successor legislation or regulation that governs the same subject matter. As used in this Escrow Agreement, “RESPA” refers to all requirements and restrictions that are imposed in regard to a “federally related mortgage loan” even if the Loan does not qualify as a “federally related mortgage loan” under RESPA.

“Single Family Residence” or “Home” means a single family private detached or attached owner-occupied house, rowhouse, townhouse or condominium containing complete living facilities and facilities functionally related and subordinate

“State” means the state in which the Property is located.

Section 1.02. Rules of Interpretation. The following principles govern the interpretation of other words and phrases used in this Agreement:

(a) Captions, titles or headings preceding any article, section or subsection herein, and any table of contents or index attached hereto, are solely for convenience of reference and are not part of this Agreement, and shall not affect its meaning, construction, or effect.

(b) Terms such as “herein”, “hereunder”, “hereby”, and “hereof” refer to this Agreement and not to any particular section hereof unless so indicated; “heretofore” and “hereafter” mean before and after the date of execution and delivery of this Agreement.

(c) Words importing the masculine, feminine or neuter genders include the other genders.

(d) Words importing persons include firms, associations, corporations, and other entities.

(e) Words importing the singular number include the plural number, and vice versa.

(f) All references in this instrument to designated “Articles”, “Sections”, “Exhibits”, “Forms”, “Schedules” and other subdivisions are to the designated Articles, Sections, Exhibits, Forms, Schedules and other subdivisions of or referenced by this instrument as originally executed or to Exhibits, Forms or Schedules as modified, amended or replaced pursuant hereto.

(g) All accounting terms not otherwise defined herein have the meanings assigned to them in accordance with generally accepted accounting principles.

ARTICLE II REPRESENTATIONS

Section 2.01. Representations, Warranties and Covenants of the Seller. The Seller represents and warrants to the parties to this Agreement that the Seller has good and marketable title to the Property, and that all statements and representations made in the BLLP Guaranty Program Application are true and correct.

Section 2.02. Representations, Warranties, and Covenants of the Mortgage Lender. The Mortgage Lender represents and warrants to the parties that the Mortgage Lender is a corporation duly organized and existing under the laws of the state in which it was incorporated, or is duly chartered or incorporated under federal law, is duly authorized to transact business in the State, and customarily provides service or otherwise aids in financing mortgages located in the State.

Section 2.03. Representations, Warranties, and Covenants of the Purchaser. The Purchaser represents and warrants to the parties that the Purchaser has the full power and authority to execute and deliver this Agreement, to accept the terms hereof, to enter into the transactions contemplated hereby.

Section 2.04 Escrow Agent Acceptance and Conditions. The Escrow Agent hereby accepts its appointment as escrow agent hereunder, but only upon and subject to the following express terms and conditions:

a. The Escrow Agent shall not be responsible or liable in any manner whatsoever for the sufficiency or correctness of the computation of the amount of the initial deposit. It is expressly understood that Escrow Agent shall act only in accordance with written notice given in accordance with this Agreement, and shall have no discretionary power in the performance of its duties hereunder.

b. The Escrow Agent shall be protected in acting upon any written notice, request, waiver, consent, certificate, receipt, authorization, power of attorney or other document, instrument or paper which the Escrow Agent in good faith believes to be genuine and to be what it purports to be.

c. The Escrow Agent shall not be liable for anything which it may do or refrain from doing in connection herewith, except as provided in d. below.

d. Notwithstanding anything herein to the contrary, the Escrow Agent shall not be liable, except with respect to acts of willful misconduct or fraud, for any liabilities, costs, expenses, or claims in connection with any act contemplated by or any matter in any way connected with this Escrow Agreement, and Seller agrees to indemnify an hold the Escrow Agent harmless from and against any such liabilities, costs, expenses, or claims.

e. The Escrow Agent may consult with legal counsel in the event of any dispute or question as to the construction of any of the provisions hereof or the duties of the Escrow Agent hereunder, and the Escrow Agent may disburse Escrow Account funds for this purpose and shall incur no liability, and shall be protected, in acting in good faith and in accordance with the opinion and instructions of such counsel.

Section 2.05. Survival of Representations, Warranties and Covenants. The representations, warranties and covenants of the respective parties hereto shall remain enforceable so long as any obligation to be performed under this Agreement remains outstanding.

ARTICLE III FEES TO THE ESCROW AGENT

Section 3.01. Fees Paid by the Seller to the Escrow Agent. The Seller acknowledges that the Escrow Agent has rendered valuable services to the Seller relating to the marketing and sale of the Property and subsequent closing of the same. The fees hereinafter set forth are deemed to be earned upon the execution of this agreement and shall paid to Escrow Agent as specified in the sections of the Escrow Agreement that follow.

Section 3.02. Initial Guaranty Fees Paid by the Seller to the Escrow Agent. The Seller shall pay to Escrow Agent _____% percent of the Purchase Price of the Property. The amount to be paid to the Escrow Agent shall be paid in all cash at closing.

Section 3.03 Annual Maintenance Fees Paid by the Seller to the Escrow Agent. For each year this Escrow Agreement is in effect Seller shall pay to the Escrow Agent an annual escrow maintenance fee of $_____, which shall be due and payable on or before December 31^{st} of each year or part of year this Escrow Agreement remains in full force and effect. Seller authorizes the payment of the annual escrow maintenance fee from the Escrow Account being held by Escrow Agent. Seller, Purchaser and Mortgage Lender hereby specifically authorize payment of annual escrow maintenance fee from the Escrow Account without further notice from the Escrow Agent.

Section 3.04. Appraisal Fees Paid by the Seller to the Escrow Agent. In connection with the Appraisal described in Article VI herein, Seller, Purchaser and Mortgage Lender hereby specifically authorize payment of Appraisal from the Escrow Account without further notice from the Escrow Agent.

Section 3.05. Initial Guaranty Fees Paid by the Purchaser to the Escrow Agent. The Purchaser shall pay to Escrow Agent _____% percent of the Mortgage Loan obtained by Purchaser in order to purchase the Property. The amount to be paid to the Escrow Agent shall be paid in all cash at closing.

Section 3.06. Initial Guaranty Fees Paid by the Mortgage Lender to the Escrow Agent. The Mortgage Lender shall pay to Escrow Agent _____% percent of the Mortgage Loan obtained by Purchaser in order to purchase the Property. The Mortgage Lender shall pay said fee to Escrow Agent at Closing. However, Mortgage Lender agrees that it shall be solely responsible for payment of fee and that the same shall not be passed on to the Borrow and shall not be part of the closing costs for the Mortgage Loan.

Section 3.07. Acknowledgment of Fees to Escrow Agent Exempt for RESPA. The parties hereby acknowledge that Escrow Agent is not providing a third-party settlement service incident to the Closing of the Property. The fees herein set forth are incident to parties' voluntary participation in the Program and are merely an ancillary benefit offered by BLLP incident to the sale of the subject property.

ARTICLE IV ESCROW ACCOUNT

Section 4.01. Establishing the Escrow Account. At Closing Seller shall pay to Escrow Agent the sum of $_____, which will be disbursed in accordance with the terms and conditions of this Article.

Section 4.02. Duration of the Escrow Account. With the exception of any payments made to Mortgage Lender set forth in Article V herein, the Escrow Agent shall hold the funds in the Escrow Account for a period of _____ years from the date of closing, which date shall be known as the Disbursement Date. During such time the Escrow Agent shall not be obligated to make any disbursement from the Escrow Account, with the exception that Escrow Agent may debit the account for the amount of the Annual Maintenance Fees described in Section 3.03 herein.

Section 4.03. Escrow Account Interest. Unless otherwise agreed to by the parties in writing the Escrow Agent shall place the funds in the Escrow Account in an interest bearing account of its choosing. Any interest earned on the funds in the Escrow Account shall be disbursed in accordance with the provisions of Articles IV and V of this Escrow Agreement.

Section 4.04. Disbursement to Seller and Purchaser. With the exception of any payments made to Mortgage Lender set forth in Article V herein, on the Disbursement Date as set forth in Section 4.02, Escrow Agent shall disburse the entire balance of the Escrow Account to the Seller and Purchaser in the following percentages: Seller to receive _____% percent of the Escrow Account and Purchaser shall receive _____% percent of the Escrow Account. However, all such payments and disbursements provided for in this Section shall be contingent on an Appraisal of Property, as contemplated in Article VI, equal or exceeding a value of $_____. In the event the Appraisal of the Property does not equal or exceed a value of $_____ then Section 4.05 shall control the disbursement of the balance of the Escrow Account.

Section 4.05. Disbursement to Purchaser. With the exception of any payments made to Mortgage Lender set forth in Article V herein, on the Disbursement Date as set forth in Section 4.02, in the event the Appraisal of the Property does not equal or exceed a value of $_____, then Escrow Agent shall disburse the entire balance of the Escrow Account to the Seller and Purchaser in the following percentages: Seller to receive _____% percent of the Escrow Account and Purchaser shall receive _____% percent of the Escrow Account.

ARTICLE V DISBURSEMENTS TO THE MORTGAGE LENDER

Section 5.01. Mortgage Lender Security Interest in the Escrow Account. Purchaser/Borrower/ Mortgagor as their interest may appear, hereby assigns, pledges and grants to the Mortgage Lender a security interest in the Escrow Account. To the extent that Seller has any ownership interest in the funds in the Escrow Account (either actual or contingent), the Seller hereby consents, grants, pledges and hypothecates such ownership interest in and to the Escrow Account to the Mortgage Lender to be held and disbursed in accordance with the provisions of this Article. Mortgage Lender's interest in the Escrow Account shall terminate on the Disbursement Date as set forth in Section 4.02 unless the funds have been previously disbursed as provided in this Article.

Section 5.02. Disbursement to Mortgage Lender Upon Mortgager's Default. In the event the Mortgagor shall default on the Mortgage or Mortgage Loan by failure to pay the sums due under the Mortgage Loan when due, the balance of the Escrow Account shall be paid to the Mortgage Lender to cure any monetary default. After curing the monetary default the remaining balance of the Escrow Account shall be paid to the Seller. In the event of a non-monetary default by Mortgagor under the terms of the Mortgage Loan the balance of the Escrow Account shall be paid to the Mortgage Lender.

Section 5.03 Mortgage Lenders Rights Cumulative . The Mortgage Lender's rights to disbursement of the funds in the Escrow Account shall be cumulative and operate in conjunction with any rights or remedies of default provided in the Mortgage Note or Mortgage Loan documents. Nothing in this agreement shall limit the Mortgage Lender's contractual or legal rights upon Mortgagor's default.

ARTICLE VI APPRAISAL OF THE PROPERTY

Section 6.01 Appraisal of the Property. Ninety (90) days prior to the Disbursement Date as set forth in Section 4.02, Escrow Agent shall engage a Qualified Appraiser to appraise the property. The Qualified Appraiser shall issue an opinion of the fair market value of the property, which shall be made available to each party to this agreement 30 days prior to the Disbursement Date as set forth in Section 4.02.

Section 6.02 Second Appraisal. Should any party to this agreement disagree with the fair market value of the property that party may at its sole cost and expense engage a licensed appraiser in the state where the Property is located to render an opinion of the fair market value of the property. This appraisal shall be presented to the Qualified Appraiser engaged by the Escrow Agent under Section 6.01 for consideration. The Qualified Appraiser engaged by the Escrow Agent shall consider the second appraisal and render a final opinion of the fair market value of the property. The parties agree to be bound by the final opinion of fair market value issued by the Qualified Appraiser engaged by the Escrow Agent.

ARTICLE VII PROTECTION OF THE PROPERTY

Section 7.01 Protection of the Property. During the term of this Escrow Agreement Purchaser shall not destroy, damage or impair the Property, allow the Property to deteriorate or commit waste on the Property. Whether or not the Purchaser is residing in the Property, Purchaser shall maintain the Property in order to prevent the Property from deteriorating or decreasing in value due to its condition. Six month prior to the Disbursement Date as set forth in Section 4.02, Escrow Agent or its agent may make reasonable entries upon and inspections of the Property.

Section 7.02 Payment of taxes and assessments. Purchaser shall pay when due all taxes and assessments on the Property.

Section 7.03 Payment of existing debt Purchaser shall comply with the terms and conditions of any Mortgage Note, Security Deed or like instrument for which the Property is pledged as security, including but not limited to timely making any payment called for in the said instruments.

Section 7.04 Damage to the Property. If the Property is damaged due to natural occurrences, fire or other hazards, (require repairs to be made acceptable to Escrow Agent, otherwise) Escrow Agent, at its sole election may terminate the Escrow Agreement and disburse the balance of the Escrow Account, less any administrative fees or expenses, to the Seller without further obligation to the Purchaser or Mortgage Lender.

Section 7.05 Insurance on the Property. During the term of this Agreement Purchaser shall keep the improvements now existing or hereafter erected on the Property adequately insured against loss by fire, hazards included within the term “extended coverage,” and any other hazards including, but not limited to, earthquakes and floods.

Section 7.06 Occupancy. Purchaser shall occupy, establish, and use the Property as Purchaser's principal residence within 30 days after execution of this Agreement and shall continue to occupy the Property as Purchaser's principal residence during the duration of this Agreement. Failure to occupy, establish, and use the Property as Purchaser's principal residence, shall be considered a breach of the Escrow Agreement and Escrow Agent shall be entitled to exercise the remedies for default.

ARTICLE VIII DISPUTE RESOLUTION

Section 8.01 Dispute Resolution. If a dispute arises out of or relates to this

Escrow Guaranty Agreement, or the Default or breach thereof, and if said dispute cannot be settled through negotiation, the parties agree first to try in good faith to settle the dispute by mediation under the Commercial Mediation Rules of the American Arbitration Association, before resorting to arbitration.

Any dispute arising out of or relating to this Escrow Guaranty Agreement, or the Default or breach thereof, that cannot be resolved by mediation within 30 days shall be finally resolved by arbitration administered by the American Arbitration Association under its Commercial Arbitration Rules, and judgment upon the award rendered by the arbitrators may be entered in any court having jurisdiction. The arbitration will be conducted in the English language in Atlanta, Georgia, in accordance with the United States Arbitration Act. There shall be three arbitrators, named in accordance with such rules.

The award of the arbitrators shall be accompanied by a statement of the reasons upon which the award is based.

The arbitrators shall decide the dispute in accordance with the substantive law of the state of Georgia.

ARTICLE IX DEFAULT

Section 9.01 Default and remedies upon Default. Failure of the parties to comply with any term or condition of the Escrow Guaranty Agreement or applicable endorsement shall constitute a Default. If the defaulting party does not cure the Default within the time specified in Section 9.02 herein, Escrow Agent, at its sole election, may terminate the Escrow Guaranty Agreement and disburse the balance of the Escrow Account, less any administrative fees or expenses, to the non-defaulting party without further obligation to the defaulting party.

Section 9.02 Notice of Default. If during the term of this Agreement a party is in Default, the Escrow Agent may send a written notice informing defaulting party of the Default. The defaulting party shall have 30 days from the date of the notice to cure the Default. Failure to cure the Default within 30 days shall entitled the Escrow Agent to exercise the remedies specified in Section 9.01 herein.

ARTICLE X MISCELLANEOUS

Section 10.01 Amendments. This Escrow Agreement may not be modified or terminated except in writing by executed by the parties hereto.

Section 10.02 Enforceability. This Escrow Agreement shall be binding upon the parties hereto (and their respective successors, executors, personal representatives and assigns), and shall inure to the benefit of the parties hereto (and their respective successors, executors, personal representatives and assigns).

Section 10.03 Counterparts. This Escrow Agreement may be executed in two or more counterparts, each of which shall be deemed an original, but all of which taken together shall constitute one and the same document.

Section 10.04 Construction. This Escrow Agreement shall be governed by, and construed in accordance with, the laws of the State of Georgia. Time is of the essence of this Escrow Agreement.

Section 10.05 Limitation of Rights. With exception of the rights herein expressly conferred, nothing expressed or mentioned in or to be implied from this Escrow Agreement is intended or shall be construed to give to any person or company other than the parties hereto any legal or equitable right, remedy or claim under or in respect to this Escrow Agreement. This Escrow Agreement is intended to be for the sole and exclusive benefit of the parties hereto.

Section 10.06 Severability. If any provision of this Escrow Agreement shall be held or deemed to be or shall, in fact, be inoperative or unenforceable as applied in any particular case in any jurisdiction or jurisdictions or in all jurisdictions, or in all cases because it conflicts with any other provision or provisions hereof or any constitution or statute or rule of public policy, or for any other reason, such circumstances shall not have the effect of rendering the provision in question inoperative or unenforceable in any other case or circumstance, or of rendering any other provision or provisions herein contained invalid, inoperative, or unenforceable to any extent whatever.

### General

The foregoing detailed description is to be understood as being in every respect illustrative and exemplary, but not restrictive, and the scope of the invention disclosed herein is not to be determined only from the detailed description of illustrative embodiments but according to the full breadth permitted by the patent laws. It is to be understood that the embodiments shown and described herein are only illustrative of the principles of the present invention and that various modifications may be implemented by those skilled in the art without departing from the scope and spirit of the invention.

Certain of the techniques disclosed herein were developed in response to the real estate crisis and the disparity between homes sold by homeowners and REO properties due to the dramatic increase the volume of foreclosures. However, techniques disclosed herein can be applied to other real estate and secured lending transactions. The techniques used in the REO-based examples described herein can be used (with or without modification) for homebuilder transactions. For example, the algorithms used to determine a Guaranty Escrow in the context of a homebuilder transaction can be based on the exemplary algorithms used to determine REO Guaranty Amounts. In the case of a homebuilder transaction, the algorithms may differ, for example, due to premiums associated with new construction as compared to existing and older houses. A system can be provided that will use general algorithms or algorithms targeted to one or more of REO properties, new construction, loan modification, secured lending transactions, and other appropriate contexts. The exemplary factors discussed in the examples above may apply to more than one such context. For example, most of the factors are applicable across all home sectors, though some weigh more than others, such as excessive inventory and market trends associated with design and updated electronics and security features. These factors have more impact on the new home value than older homes, which are functionally obsolete in many respects while being considerably cheaper to construct. Therefore, algorithm adjustments may be used to adjust for every market and submarket accordingly. There are many other segments to consider, but not limited to, such as corporate relocations, traditional home sales, newly emerging rent to own markets, as well as investor for sale/rent properties. Each of these segments have characteristics that require adjustments to the algorithms, but use the basic concepts disclosed herein, as will be recognized by those of skill in the art

Embodiments of the present disclosure may comprise systems having different architecture and methods having different information flows than those shown in the Figures. The systems shown are merely illustrative and are not intended to indicate that any system component, feature, or information flow is essential or necessary to any embodiment or limiting the scope of the present disclosure. The foregoing description of the embodiments has been presented only for the purpose of illustration and description and is not intended to be exhaustive or to limit the disclosure to the precise forms disclosed. Numerous modifications and adaptations are apparent to those skilled in the art without departing from the spirit and scope of the disclosure.

Some portions of the detailed description have been presented in terms of algorithms or processes which may take the form of a series of operations on data or signals stored in a computer memory. As a result, these operations take the form of manipulation or transformation of physical quantities. Such quantities may in some instances take the form of electrical or magnetic signals capable of being transformed, stored, retrieved, compared, combined or otherwise manipulated. It is to be understood that all such references to algorithms and processes also refer to the underlying physical quantities and their transformations and manipulations. Similarly, references herein to terms such as “computing,” “processing,” “determining,” and similar terms refer to the actions of a computer or similar platform that transforms or otherwise manipulates data stored as physical quantities within the computer or platform.

Additional embodiments include a computer readable medium or media tangibly embodying program code for implementing one or more aspects of the present subject matter. As an example, embodiments can include media embodying program code executable by one or more processors of a computing system to cause the system to implement methods of treating, disposing, and/or restoring dormant accounts with one or more aspects of the present subject matter as noted herein.

Any suitable computer-readable medium or media may be used to implement or practice the presently-disclosed subject matter, including, but not limited to, diskettes, drives, magnetic-based storage media, optical storage media, including disks (including CD-ROMS, DVD-ROMS, and variants thereof), flash, RAM, ROM, and other memory devices, and the like.

I claim:

1. A method comprising:
receiving assets to be held in an account, the assets associated with a sale of real estate from a seller to a buyer;
restricting the account so that at least a portion of the assets are disbursed from the account to the buyer or a lender only if a loss resale event occurs in which the real estate is resold by the buyer or lender for a loss within a specified period; and
in response to determining that the loss resale event has occurred, disbursing the portion of the assets to the buyer or lender to at least partially remedy the loss.

2. The method of claim 1 further comprising managing the account in accordance with features customized according to provisions of an agreement associated with the sale of the real estate.

3. The method of claim 1 wherein the assets comprise money.

4. The method of claim 1 wherein disbursing the portion of the assets comprises prioritizing distribution of assets to the lender over distribution of assets to the buyer.

5. The method of claim 1 wherein the assets to be held in an account are determined based at least in part on an estimate of real estate owned (REO) value of the real estate.

6. The method of claim 1 wherein the assets to be held in an account are determined based at least in part on an estimate of market value of the real estate.

7. The method of claim 1 wherein the assets to be held in an account are determined based at least in part on a difference between an estimate of market value of the real estate and an estimate of real estate owned (REO) value of the real estate.

8. The method of claim 1 wherein managing the account further comprises disbursing at least a portion of the assets to the seller if a loss resale event does not occur within the specified period.

9. The method of claim 1 wherein the portion of the assets is all of the assets.

10. The method of claim 1 wherein managing the account comprises a processor of a computer device sending electronic messages to control disbursement.

11. The method of claim 1 wherein the assets associated with the sale are assets associated with funds borrowed by the buyer at the time of the sale.

12. The method of claim 1 wherein the assets associated with the sale are assets associated with funds borrowed by the buyer during a refinancing or loan modification occurring after the sale.

13. The method of claim 1 further comprising receiving
restricting the account so that at least a portion of the assets are disbursed from the account to a lender only if a principal-and-interest default event occurs in which a borrower who borrowed money in connection with the sale of real estate from the seller to the buyer fails to make principal-and-interest payments in accordance with lender requirements; and
in response to determining that the principal-and-interest default event has occurred, disbursing the portion of the assets to the lender to at least partially remedy the default.

14. A method comprising:
determining an estimate of a market value of real estate;
determining an estimate of a real estate owned (REO) value of the real estate; and
determining, by a processor of a computer device, assets to be held in an account based at least in part on:
the estimate of the market value of the real estate;
the estimate of the REO value of the real estate; and
a purchase price of the real estate paid by a buyer to a seller,
wherein the assets are determined to protect the buyer if a loss resale event occurs in which the real estate is resold by the buyer for a loss within a specified period.

15. The method of claim 14 wherein determining an estimate of a market value of real estate comprises determining a geographic-area-specific estimate of the market value of the real estate based on a geographic location of the real estate.

16. The method of claim 14 wherein determining an estimate of a REO value of real estate comprises determining a geographic-area-specific REO value based on a geographic-area-specific estimate of the REO value of the real estate based on a geographic location of the real estate.

17. A method comprising:
receiving from a buyer an offer to purchase real estate from a seller for a first value;
determining, by a processor of a computer device, a second value greater than the first value based at least in part on:
an estimate of the market value of the real estate;
an estimate of the REO value of the real estate; and
an amount of funds to be held in an account; and
providing the second value for use in making a counter offer for the buyer to purchase the real estate for a purchase price equal to the second value subject to the amount of funds to be taken from the purchase price and to be held in the account, wherein the account is to be managed so that at least a portion of the funds is disbursed from the account to the buyer or a lender only if a loss resale event occurs in which the real estate is resold by the buyer for a loss within a specified period, wherein the portion of funds disbursed from the account is equal to or less than the loss.

18. A method comprising:
receiving assets to be held in an account, the assets associated with lending from a lender to a borrower, the lending secured by real estate;
restricting the account so that assets are disbursed from the account to the borrower or the lender only if a triggering event occurs within a specified period;
in response to the occurrence of the triggering event:
determining a portion of the assets to disburse based at least in part on:
a sale price less than a value of the real estate determined at the time of the lending; or
on an appraisal determining that the market value of the real estate is less than a value of the real estate determined at the time of the lending; and
disbursing the portion of the assets to the borrower or lender.

19. The method of claim 18 in which the triggering event is a refinancing or other loan modification.

20. The method of claim 18 in which the triggering event is determined at the discretion of the buyer.
